(19) United States
(12) Patent Application Publication
(10) Pub. No.: US 2009/0182458 A1
(43) Pub. Date: Jul. 16, 2009

(54) Method for Deactivating at least one Control Part of a Converter Device

(75) Inventors: Gerhard Heinemann, Erlangen (DE); Eckart Krebber, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/575,452

(22) PCT Filed: Sep. 13, 2005
(86) PCT No.: PCT/EP05/54546

§ 371 Date: Mar. 16, 2007

(30) Foreign Application Priority Data
Sep. 17, 2004 (DE) 10 2004 045 197.4

(51) Int. Cl. G06F 1/26

(52) U.S. Cl. 700/295

(57) ABSTRACT

The invention relates to a method for deactivating at least one control part (1) of a semiconductor converter (5) and to a corresponding control part (1). The semiconductor converter (5) consists of the control part (1) and a semiconductor converter part (3) and the deactivation request (33) is received by the control part (1) or is present in said part. At least one data processing operation (35, 37, 39) is then carried out and deactivation preparation information (59) is generated. The deactivation preparation information can then be used, for example, to release the deactivation of the power supply for the control part.

The invention relates to a method for deactivating at least one control part of a converter device and to a corresponding control part of a converter device.

A converter device has a control part and a converter part. The converter part has power semiconductor components which are provided to direct current. The control part has a control device which is provided to control the converter. An electric motor, for example of a synchronous machine, an asynchronous machine, a torque motor or a linear motor, can also be controlled by means of this control part. A control system, which can be implemented in the control part, has, for example, a position controller, a rotational-speed controller, a speed controller, a torque controller, a current controller and/or the like. The control part and the converter part of the converter device are, for example, accommodated in a common housing or else in two different housings. If the control part and the converter are accommodated in one housing and the individual parts can no longer be exactly separated from one another, a control part is understood to be a converter device which has a control device in the form of a control part and a converter part.

The converter device can be used particularly in a handling machine or in a machine tool or a production machine, for example. A machine tool is understood to be, for example, a single-axis or multi-axis turning, milling, drilling or grinding machine. Within the scope of the present invention, machine tools also include processing centers, linear and rotary transfer machines, laser machines or hobbing and gear-cutting machines, for example. Within the scope of the present invention, production machines include, for example, textile-, plastic-, wood-, glass-, ceramic- or stone-processing machines.

Control parts of converter devices are digitally controlled using microcomputers. The parameters which are required to adapt to a respective system and/or machine are stored in a non-volatile memory. After individual parameters are entered or after commissioning of the converter device is complete, the parameters are transferred in a non-volatile memory of the control part of the converter device. Under certain circumstances, there are also, for example, further write operations to the non-volatile memory, for example for storing fault messages, logbook entries of recorded measured values. Recorded measured values can, for example, be stored in a trace file. As converter devices or their control parts become more complex, the amount of this data continuously increases.

If the power supply is interrupted during a write operation to a non-volatile memory, data may be lost. If, in the case of a converter device, the power supply is disconnected and a Compact Flash card, for example, is used as a storage medium in this converter device, problems arise because the write behavior is not precisely specified in a Compact Flash card. This means that the length of time in which a write operation or a write task is ended on the Compact Flash card is not established in advance. Therefore, data may be lost and inconsistencies may occur when the control part is deactivated. Even greater problems may occur if the data which is to be stored on a storage medium is stored in the form of a file system. If, for example, power is cut during writing of a file allocation table (FAT) or during writing of a file directory, data in the file system may be destroyed, with the result that the entire contents of the storage medium becomes unusable.

According to the prior art, converter devices have, for example, a light-emitting diode which indicates the write operations to the non-volatile memory. Accordingly, the converter device can only be deactivated when the light-emitting diode is not lit. Since converter devices are installed in a switchgear cabinet in many cases, it is generally only possible to use a light-emitting diode for control purposes during commissioning. For this reason, the prior art avoids permitting automatically running write operations to a non-volatile memory of the converter device during normal operation. Write operations of this type are, for example, writing of logbook entries and/or storage of measured values in a trace or in a trace file. According to the prior art, write operations of this type are therefore avoided as far as possible since data is likely to be lost in the event of the converter device being deactivated.

The object of the present invention is therefore to specify a method for deactivating at least one control part of a converter, which method at least reduces the above-described disadvantages which may occur when the control part is deactivated.

This object is achieved by means of a method according to claim 1 and by means of a control part having the features of claim 5. Dependent claims 2 to 4 and 6 to 8 are further inventive refinements of the method and, respectively, of the control part.

In a method for deactivating at least one control part of a converter device, with the converter device having at least the control part and a converter part, a deactivation request is made to the control part. The deactivation information is, for example, generated internally in the control part or transmitted to the control part via a data-transmission means. Furthermore, it is, for example, possible for the deactivation information to be generated by a user via a machine interface, for example an operator control device, and made available to the control part for processing purposes. If the deactivation information is available in the control part, at least one data-processing operation is then executed. The data-processing operation serves particularly to save data. An item of information relating to readiness for deactivation is generated after the data-processing operation or operations are complete. The deactivation information is, for example, processed internally in the converter device or else internally in the control part in such a way that the control part is disconnected from a voltage source. The voltage source is an example of a power supply. A further way of using the deactivation information is to output it externally, with the result that said deactivation information leads to a power supply of the control part, for example, being deactivated outside the control part and/or outside the converter device.

To this end, the control part has, in particular, at least one microprocessor for data-processing purposes.

A deactivation operation can be initiated by means of the deactivation request. The deactivation operation includes processing data-processing operations. It is therefore possible to execute at least one data-processing operation or else a plurality of data-processing operations. The data-processing operation is, for example, defined in advance. It is possible to save files in a non-volatile memory by means of the data-processing operation. It is also possible, for example, to execute macros or programs by means of a data-processing operation. The data-processing operation is, for example, implemented as a data-processing program. The decision as to which macro or which program is to be executed is defined in advance, for example in the data-processing program. If one data-processing program or all data-processing programs which are started by means of the deactivation request is/are terminated, or termination is performed, in particular without faults being reported, it is possible to generate an item of information relating to readiness for deactivation. The information relating to readiness for deactivation is, for example, an enable operation for deactivating an electrical power supply which is provided particularly to supply electrical power to the control part.

It is therefore possible to use the method according to the invention to define ordered execution of the deactivation process, in particular of the electronics power supply of the control part, for a control part of a converter device and also for a converter device. The electronics power supply is provided in the form of a power supply, particularly for supplying a microprocessor and/or a memory device for digital data. In this case, automatic activation of predefined macros or programs not only enables correct storage of non-volatile data, but can, for example, also be used to move a machine mechanism to a park position. In addition, a superordinate control system or an operator control unit can be informed of an imminent deactivation of a drive in this phase, with the result that the superordinate control system can likewise carry out corresponding deactivation measures without, for example, fault messages such as “communication with the drive interrupted” being generated. Fault messages of this type can be suppressed. In one advantageous refinement, the deactivation request to one control part is transmitted to a further control part and/or a control system, in particular a control system of a machine tool or a production machine.

The information relating to readiness for deactivation advantageously enables and/or initiates electrical disconnection of the control part from an electrical power supply. The electrical power supply is provided at least to supply the control part with power. The enable operation serves, for example, to suppress or else to eliminate a signal which has prevented the power supply from being switched off.

In further advantageous refinements of the invention, the deactivation request is executed in an extremely wide variety of ways. The deactivation request which represents initiation of the deactivation operation, can, for example, be carried out as follows:
by means of the writing of an acyclic control parameter, for example via a field bus communication, by a superordinate control system or an operator control unit;
by means of a cyclical read process signal which can be generated externally. This may be a control bit which is transmitted by a superordinate control system, for example via a field bus. However, transmission may also be performed via a terminal signal, for example a digital 24 V input terminal;
by means of internal triggering, for example by means of a sequence programmed in the converter device (called converter for short) in accordance with a user program or as a reaction to a fault which has occurred.

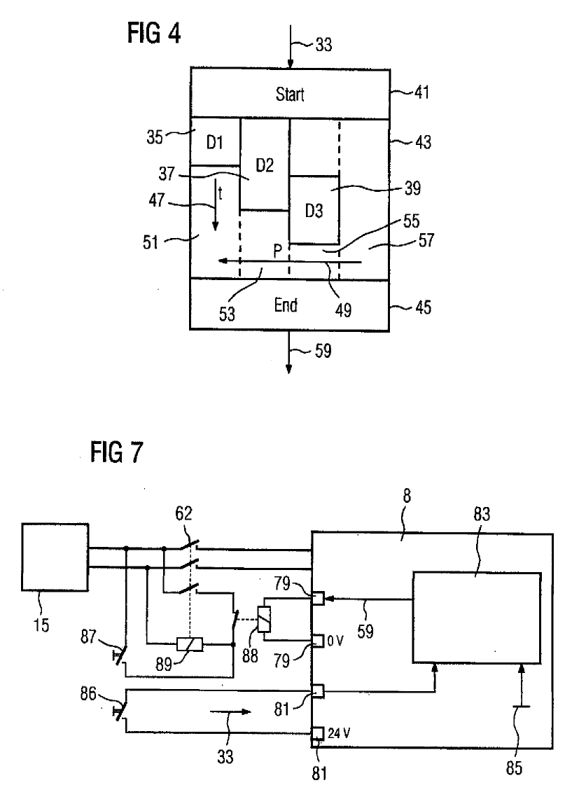

In a further advantageous refinement, processing operations, for example a macro and/or a program, run in different time execution levels of the control part. The fact that the software and runtime software of a control part have different execution levels is described below, particularly in FIGS. 4 to 6. Various data-processing operations having different priorities can then be assigned as a function of the priority of the data-processing operation to be processed, with the result that some data-processing operations can run more quickly than others. It is therefore possible to prioritize more important data-processing operations before less important data-processing operations and some data-processing operations can be processed more quickly than others.

In a further embodiment of the method, a data-processing method carries out at least one of the following functions:
ensuring termination of a running write operation to a non-volatile memory,
starting and/or executing a write operation, particularly to a non-volatile memory for data,
starting and/or executing a programmed macro,
starting and/or executing a program, particularly for movement control,
starting and/or executing a parameterization operation which relates to setting a counter, for example.

The write operation, the macro, the program or the parameterization operation is advantageously executed until the end of the write operation, the macro, the program or the parameterization operation.

Additional starting and complete execution of additional write operations is therefore possible by means of one data-processing operation. This is used, for example, to transmit data from a RAM to a non-volatile memory. This saves on continual, cyclical write operations for the corresponding, changing data during operation of the converter device or of the control part to at least one non-volatile storage medium which usually permits only a limited number of write cycles.

If a data-processing program concerns additional starting and/or complete execution of a user-defined parameter macro, it is therefore clear from this that this makes possible a flexible user-definable reaction to a deactivation operation before deactivation.

Additional starting and complete execution of user programs, for example a user program for a specific positioning program which moves a movable machine part to a defined park position, provides a data-processing program with a function which enables a machine to be moved to define positions before the control part is deactivated in order to prevent the machine from being damaged by the control part being deactivated.

In further advantageous refinements of the method, the information relating to readiness for deactivation can be used and formed in a wide variety of ways. The information relating to readiness for deactivation concerns, for example, setting an acyclic read parameter to a value which indicates that the converter device or the control part is ready for deactivation. This read parameter may, for example, be read out by a superordinate control or operator control unit which then triggers the actual electrical deactivation operation, for example by a switching contactor. In a further refinement, the information relating to readiness for deactivation can be signalled externally by means of a terminal signal. The control part and/or the converter device have, for example, a terminal for this purpose. The terminal signal may, for example, be applied to a 24 V output terminal which directly actuates a contactor circuit, with the contactor circuit being provided for switching on and switching off the power supply for at least the control part. As an alternative or in combination, the terminal signal can also be transmitted to process data of a field bus communication via a control bit. If the converter device has an internal electrical deactivation apparatus, for example a contactor for the electrical power supply of the control part or the electronics of the control part, and the deactivation apparatus is directly integrated in the converter, said deactivation apparatus can also be directly actuated.

Consequently, a deactivation mechanism for an electronics power supply of a control part can be formed by means of the invention. Processes, for example handshaking, via parameters or process signals can be used for automated execution of the shutdown mechanism (that is to say the mechanism for deactivating the control part). A range of operations, in particular data-processing operations, running during shutdown (deactivation) can be advantageously parameterized and/or programmed by the user. The operations, in particular data-processing operations, running during shutdown may contain user-projected parameter macros or programs.

The various methods according to the invention can be used in a control part of a converter device, with the result that the invention accordingly relates to a control part of this type too. This control part then has the above-described features of the invention.

Exemplary embodiments of the invention are explained in greater detail in the text which follows and illustrated in the drawing, in which

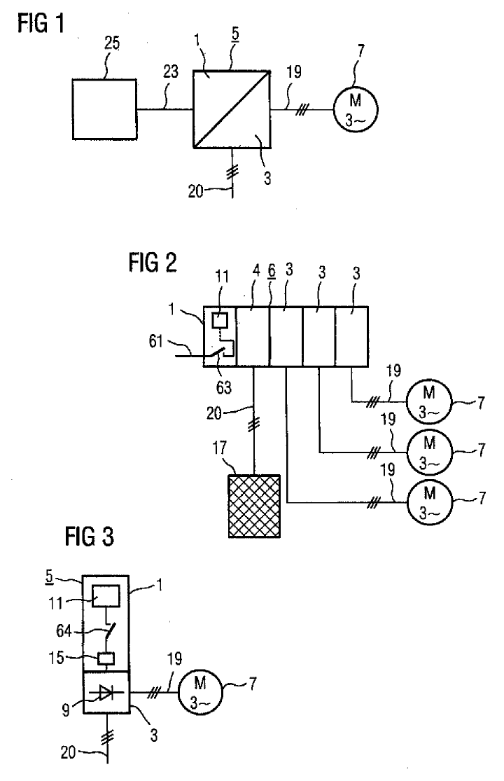

FIG. 1 shows a first converter device,

FIG. 2 shows a second converter device,

FIG. 3 shows a third converter device,

FIG. 4 shows a method sequence,

FIG. 5 shows an execution level for a classic programmable logic controller PLC,

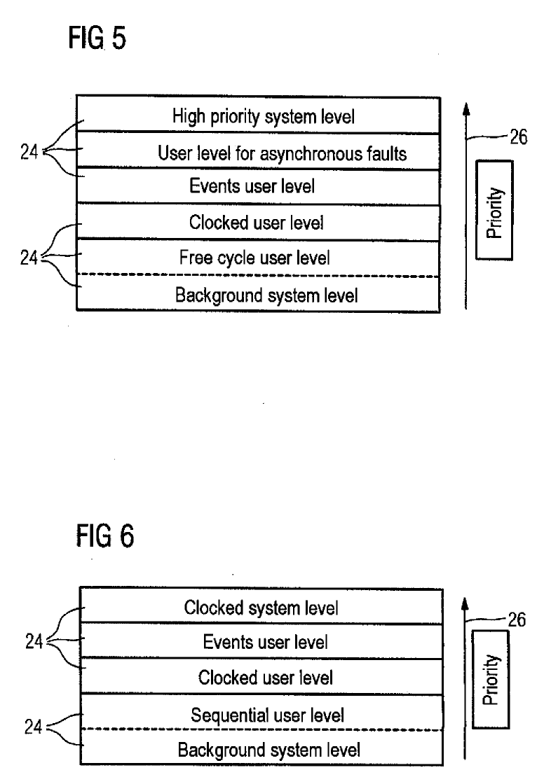

FIG. 6 shows an execution level for movement control, and

FIG. 7 shows an electrical connection for the converter device.

The illustration of FIG. 1 shows a converter device 5. The converter device 5 has a control part 1 and a converter part 3. The converter device 5 is connected to a programmable logic controller PLC for data purposes via a data connection 23. The converter part 3 has power semiconductors which are not illustrated in FIG. 1. The converter part 3 is supplied with power by means of an electrical power connection 20. The converter part 3 is, for example, a power converter. The power converter allows, for example, a three-phase AC voltage to be converted into a three-phase AC voltage with variable frequency. An electrical machine 7, for example, can be driven with a three-phase AC voltage with variable frequency. The electrical machine 7 is connected to the converter part 3 by means of an electrical power connection 19.

The illustration of FIG. 2 shows a converter device 6 which has a control part 1 and four converter parts 3, 4, with the converter parts 3 being provided for feeding electrical machines 7 and the converter part 4 being provided for rectifying a three-phase AC voltage which can be fed in via the electrical power connection 20. The electrical power is supplied by a power supply or a power supply network 17. The control part 1 is supplied with power by means of a separate power supply 61. A switch 63 is provided in order to disconnect the electronics 11 for the control part 1 from the separate power supply 61. In contrast, the illustration of FIG. 1 shows a control part 1 which obtains its power supply from the electrical power connection 20.

The illustration of FIG. 2 shows that a converter device 6 can not only comprise one device part, that is to say a device with just one housing, but that this converter device 6 can also comprise parts which each have a separate housing. The converter parts 3 and 4 are, like the control part 1, separately in a housing. The housings are, for example, arranged next to one another in a frame or in a switchgear cabinet.

The illustration of the FIG. 3 shows a converter device 5, with this converter device 5 having a control part 1 and a converter part 3. The converter part 3 has power semiconductors 9, of which one is symbolically illustrated. The control part 1 has electronics 11, it being possible to supply the electronics 11 with power via an electronics power supply 15. The electronics 11 of the control part 1 can be disconnected from this power supply 15 by means of a switch 64.

The illustration of FIG. 4 shows execution of a deactivation operation according to the method, with a deactivation request 33 initiating a start 41 of data-processing operations 35, 37, 39. The data-processing operations D1 35, D2 37 and D3 39 are started at different times. The different start times over a time profile 47 are indicated by the different positions of a block, of which the data-processing operations D1 35, D2 37 and D3 39 are illustrated. The data-processing operations D1 35, D2 37, and D3 39 are therefore processed in a processing block 43. If the control part or the software which runs on this control part has different execution levels 51, 53, 55, 57, these execution levels are divided in accordance with a prespecified priority 49. According to FIG. 4, data-processing operations are each assigned to an execution level 51, 53, 55, 57. The figure does not show that at least two data processing operations are assigned to one execution level. After processing of the data-processing operations D1 35, D2 37 and D3 39, an item of information 59 relating to readiness for deactivation is output at the end 45.

The illustration of FIG. 5 shows the main execution levels 24 of a classic programmable logic controller, arranged in accordance with their priority. Execution levels of this type are, for example, also implemented in a control part. The increase in priority is symbolized by an arrow 26. In a level with the lowest priority, which is an execution level 24, two different tasks, namely a free cycle, that is to say “free cycle user level” and a background system level, that is to say “background system level” are processed using a round robin method, that is to say controlled by time slots. Communication tasks, for example, are assigned to the background system level. In a subsequent clocked user level 24, called “clocked user level”, the call-up clock of the tasks or of the programs of this level can be parameterized. Monitoring takes place to ascertain whether the processing of a user program of this clocked level has been completed in time before the start event occurs once again. If the clock time elapses without the user program of the assigned level being processed to completion, a corresponding task of a “user level for asynchronous faults”, which is next but one in terms of priority, is started. In this “user level for asynchronous faults”, the user can program out the handling of fault states. The user program is software which is provided for operation of the open-loop control device but also of the closed-loop control device.

The “clocked user level” is followed by an “events user level”. The response to external or internal events takes place within the “events user level”. A typical example of such an event is a limit value being exceeded. The tasks of the operating system, which ensure operation of the programmable logic controller (PLC), are situated in a “high priority system level”.

The illustration of FIG. 6 shows the main execution levels 24 of a movement controller, for example an NC device or else a CNC device. In this case too, the individual levels are arranged hierarchically according to their priority, as symbolized by an arrow. This model of execution levels can also be implemented in a control part, for example. A “background system level” and a “sequential user level” have an equal priority, specifically the lowest priority. This unity in terms of tasks is symbolized by a dashed line, as in FIG. 5. The tasks of the “sequential user level” are processed together with the tasks of the “background user level” in the round robin process. Typical tasks of the “background user level” are, for example, those for communication tasks. The program parts, which are programmed by the user, for the actual control task run in the “sequential user level”. If, in one of these program parts, the controller encounters a movement or positioning command, a “suspend” is set, that is to say the user program is interrupted at this point. This movement or positioning command is processed in a “clocked system level” which has the highest priority. Each and every position controller which runs in the “clocked system level” executes this movement or positioning command. After execution of the command, the process returns to the “sequential user level” and the user program interrupted by “suspend” is continued at the same point by a “resume”. The “clocked system level” contains not only the abovementioned position controllers but also the interpolation part of the controller.

The illustration of FIG. 7 shows an exemplary embodiment in which the method according to the invention automatically deactivates an electronics power supply 15 by means of the contactor 88. The illustration shows a converter device 8 which has an output terminal 79 and an input terminal 81. A shutdown mechanism (deactivation mechanism) 83 is programmed in the converter device 8, it being possible to save parameters 85 by means of the shutdown mechanism 83. The converter part of the converter device 8 is not illustrated in the illustration of FIG. 7. A deactivation request 33 may be made to the converter device 8 by means of a key 86 which is, for example, labelled with “off”. The deactivation request 33 triggers the shutdown mechanism. At least one data-processing program is started by the shutdown mechanism. The data-processing program is, for example, provided to save parameters 85. After the data-processing program has been carried out, an item of information 59 relating to readiness for deactivation is applied to the output terminal 79. A switch 62 is now opened by means of a contactor 88 when the item of information 59 relating to readiness for deactivation is present.

A key 87, for example, is also provided which allows the switch 62 to be closed by means of the contactor 89. The contactor 89 and its actuation means can also be integrated in the converter device 8, but this is not illustrated in FIG. 7. As an alternative, the contactor 89 can also be actuated by a superordinate control system or by an operator control device which communicates with the converter device 8 via a field bus. This is not illustrated in the illustration according to FIG. 7 either.

1.-8. (canceled)

9. A method for deactivating at least one control part of a converter device, with the converter device having the at least one control part and a converter part, said method comprising the steps of:
sending a deactivation request to the control part;
executing at least one data processing operation, and
generating a message indicating readiness for deactivation of the control part.

10. The method of claim 9, further comprising the step of disengaging or initiating electrical disengagement of the control part from an electrical power supply.

11. The method of claim 9, wherein a plurality of data processing operations are performed which run in different time execution levels of the control part.

12. The method of claim 9, wherein the at least one data-processing operation carries out at least one of the following functions:
a) ensuring termination of a running write operation to a non-volatile memory,
b) starting and/or executing a write operation,
c) starting and/or executing a programmed macro,
d) starting and/or executing a program,
e) starting and/or executing a parameterization operation.

13. The method of claim 12, wherein the program involves a movement control.

14. A control part of a converter device, with the converter device having a converter part in addition to the control part, said control part configured to execute a data processing operation in order deactivate at least the control part.

15. The control part of claim 5, constructed for release and/or initiation of an electrical disengagement thereof from an electrical power supply in response to the data processing operation.

16. The control part of claim 14, wherein the data processing operation performs at least one of the following functions.
a) ensuring termination of a running write operation to a non-volatile memory,
b) starting and/or executing a write operation,
c) starting and/or executing a programmed macro,
d) starting and/or executing a program,
e) starting and/or executing a parameterization operation.

17. The control part of claim 16, wherein the program involves a movement control.

18. The control part of claim 14, constructed for executing a method for deactivating the control part by sending a deactivation request to the control part, executing at least one data processing operation, and generating a message indicating readiness for deactivation of the control part.
